(19) United States
(12) Patent Application Publication
(10) Pub. No.: US 2024/0416422 A1
(43) Pub. Date: Dec. 19, 2024

(54) GENERATIVE LAYER-BUILDING PROCESS WITH VARIOUS RAW-MATERIAL POWDERS, AND INSTALLATION THEREFOR

(71) Applicant: Nikon SLM Solutions AG, Lübeck (DE)

(72) Inventors: Milovan MACIC, Lübeck (DE); André THIEMANN, Lübeck (DE)

(21) Appl. No.: 18/695,075

(22) PCT Filed: Oct. 24, 2022
(86) PCT No.: PCT/DE2022/200241

§ 371 Date: Mar. 25, 2024

(30) Foreign Application Priority Data
Nov. 10, 2021 (DE) 10 2021 212 624.3

(51) Int. Cl. B22F 10/73; B22F 10/37; B22F 12/58; B33Y 10/00; B33Y 30/00; B33Y 40/00

(52) U.S. Cl. CPC B22F 10/73; B22F 10/37; B22F 12/58; B33Y 10/00; B33Y 30/00; B33Y 40/00

(57) ABSTRACT

A facility is for the manufacture selectively of a first workpiece from a first raw material powder in a first construction job by way of a generative layer construction method and a second workpiece from a second raw material power in a second construction job by way of a generative layer construction method. The facility includes a raw material powder routing for leading the first and/or second raw material powder during a construction job. The facility includes a cleaning operation mode, concerning which a cleaning quantity of second raw material powder is led through a section of the raw material powder routing between the first construction job and the second construction job and a raw material powder mixture with a residual share of a first raw material powder is led away out of the section of the raw material powder routing.

The present disclosure relates to a generative layer construction method with different raw material powders and a facility for this, in particular by way of laser powder bed fusion (LPBF). Furthermore, the present disclosure relates to a control program in the form of software and/or hardware for such facility, for carrying out the method.

The manufacture of three-dimensional workpieces by way of a generative layer construction method is often denoted as 3D printing. A particular form of a generative layer construction method is laser powder bed fusion (LPBF), concerning which a material to be processed is deposited as a raw material in powder form in a thin layer on a base plate. The powder-like raw material is fused or sintered in a selective, i.e. locally specific manner by way of laser radiation and after solidification forms a layer of the workpiece. As soon as a workpiece layer is completed, the base plate is lowered by a magnitude of a layer thickness and the raw material powder is deposited for the next layer which is then selectively fused or sintered again by way of laser radiation. This so-called “construction job” is repeated until all fused workpiece layers together form the three-dimensional workpiece. The base plate lowers into a workpiece space step by step during the construction job, said construction space being enclosed by a workpiece surround at the periphery. The workpiece space therefore in the course of the construction job increases with the growing three-dimensional workpiece, wherein that volume of the workpiece space which is not filled by the three-dimensional workpiece is filled by raw material powder which has not fused. E.g. ceramic, metal or plastic materials can serve as a material powder, or also material mixtures of these or mixtures of different types of ceramic, metal or plastic materials.

A facility for a generative layer construction method for creating workpieces is often not limited to only being able to be operated with one type of raw material powder. Some multi-material facilities can manufacture workpieces of two or more different raw material powders, wherein however the different raw material powders are led in the facility in a manner in which they are separate from one another (see e.g. WO 2014/111072 A1). Independently of whether it is the case of a single-material facility or a multi-material facility, different types of raw material powder can be used for different construction jobs. However, before a raw material powder other than that used in the preceding construction job can be used in a new construction job in the same raw material powder routing of the facility, usually the respective raw material routing of the facility must be thoroughly cleaned, so that the new workpiece comprises no intolerably high residual shares of the preceding raw material powder. Depending on the raw material powder concerned, the limits to respective contamination can be quite strict, in order to be able to ensure a high material quality of the workpiece.

The thorough cleaning of a facility however often entails a very high manual work effort, concerning which many parts of the facility need to be disassembled, individually vacuumed and/or cleaned by hand and finally re-assembled again. Depending on the size of the facility, this can assume several hours and even days of specially trained and experienced personnel. Added to the respective cleaning costs are the operational downtime costs for the time in which the facility cannot be operated.

It is therefore the object of the present disclosure to reduce the time and the costs for the cleaning of a facility between two construction jobs with different raw material powders.

This object is achieved by a facility, a generative layer construction method and a control program according to one of the independent claims. Preferred embodiments are to be derived from the dependent claims, the description and the drawings.

According to a first aspect of the present disclosure, a facility is provided for the manufacture of selectively
at least one first workpiece from at least one first raw material powder in a first construction job by way of a generative layer construction method and
at least one second workpiece from at least one second raw material power in a second construction job by way of a generative layer construction method,
   wherein the facility comprises at least one raw material powder routing for leading the first and/or second raw material powder during a construction job, characterised in that the facility comprises a cleaning operation mode, concerning which a cleaning quantity of second raw material powder is led at least through a section of the raw material powder routing between the first construction job and the second construction job and a raw material powder mixture with a residual share of a first raw material powder is led away out of the section of the raw material powder routing.

The raw material powder routing encompasses all parts of the facility which come into contact with the respective raw material powder. The raw material powder can be transported for example by way of gravity, mechanically and/or fluidically along the raw material powder routing. The section of the raw material powder routing through which the cleaning quantity of second raw material powder runs in the cleaning operation mode can extend over the complete raw material powder routing or only one or more parts thereof. The raw material powder routing can optionally comprise a recycling system, so that a least parts of the raw material powder are transported cyclically through the raw material powder routing. The section of the raw material powder routing through which the cleaning quantity of second raw material powder runs in the cleaning operation mode in particular then extends over the recycling system. A multi-material facility can comprise several raw material powder routings which are largely separate from one another. In this case, the cleaning operation mode can be provided separately for at least one section of one, several or all raw material powder routings. In particular, sections of the raw material powder routing in which the raw material powder is transported fluidically along a pipe conduit by way of overpressure or vacuum are very difficult or not at all able to be cleaned manually without previously having to disassemble parts of the raw material powder routing and subsequently reassemble them again. For this reason, the cleaning operation mode is advantageous in particular for such sections of the raw material powder routing.

The section of the raw material powder routing which is to be cleaned in the cleaning operation mode preferably leads through a process chamber in which the raw material powder is selectively fused in a layered manner as a powder bed during a construction job. Optionally, in the second mode too, the cleaning quantity of second raw material powder is fed to the process chamber in a layered manner as a powder bed and the raw material powder mixture is led away out of the process chamber. However, in contrast to the construction job, the powder bed is not selectively fused in the cleaning operation mode. This has the advantage that an existing conventional facility can be adapted merely by way of installing or carrying out a software update, in order to be able to execute the cleaning operation mode according to the invention without having to adapt or change the hardware of the facility.

In the cleaning operation mode, the second raw material powder is therefore conveyed through the facility just as is the case during the construction job, but with the difference than no laser is operated in order to selectively fuse the powder bed. The cleaning operation mode can therefore be denoted as a “powerless” dummy construction job or “0-Watt construction job”. The cleaning quantity of second raw material powder cleans at least the section of the raw material powder routing which is to be cleaned in the cleaning operation mode, by way of the second raw material powder entraining any residual shares of first raw material powder and mixing it into the cleaning quantity. By way of this, the residual share of first raw material powder which is located in the section of the raw material powder routing which is to be cleaned in the cleaning operation mode is led away together with the second raw material powder as a raw material powder mixture. Therefore the cleaning between the two construction jobs with different raw material powders is automated by way of the cleaning operation mode, which significantly reduces the time and the costs for the cleaning. It is particularly with larger facilities and/or facilities with an automatic raw material powder recycling, thus a cyclical raw material powder routing, that the advantage of the cleaning operation mode is huge compared to a manual cleaning.

It is also conceivable for the section of the raw material powder routing which is to be cleaned, although leading through the process chamber, however for no powder bed to be built up in the cleaning operation mode. The cleaning quantity of the second raw material powder, in contrast to the construction job in the cleaning operation mode can fall and/or to be transported directly into an overflow or capture container. For this, a coater which lays out the powder bed in the construction job can be accordingly controlled to convey directly into an overflow or capture container in the cleaning operation mode. There are also facilities concerning which an overflow or capture container is located directly below an intermediate store at one or both sides of the powder bed, from which intermediate store a coater in the construction job is filled for laying out the powder bed. Concerning such facilities, it is conceivable in the cleaning operation mode for the cleaning quantity of second raw material powder to fall directly from the intermediate store into the overflow or capture container. Herein, the coater can be positioned therebetween and be open to the bottom in order to likewise be rinsed, or to be moved out of the raw material powder routing, in order indeed not to be rinsed. Alternatively or additionally, in the cleaning operation mode it is conceivable for the cleaning quantity of second raw material powder to be conveyed directly into a workpiece container which is positioned below the process chamber, if for example a base plate for the powder bed is positioned in a position which is lowered in the workpiece container. The cleaning operation mode can also be used in facilities concerning which during a construction job the raw material powder is transported upwards as a powder heap laterally of the powder bed and a coater in the form of a doctor blade laterally smoothly wipes the powder heap into a powder bed.

However, concerning the cleaning operation mode it is predominately a case of cleaning those sections of the raw material powder routing of the facility which are difficult or not at all possible to clean manually without previously having to disassemble parts of the facility and to subsequently reassemble them. These for example are pipe conduits in which the raw material powder is transported. Depending on the construction and accessibility of the process chamber, it can indeed be the case that the process chamber, possibly including the intermediate store, coater and overflow is relatively easy to clean manually without disassembly of parts. The cleaning quantity of the second raw material powder therefore in the cleaning operation mode does not necessarily need to be led through the process chamber. For example, one can provide a cleaning bypass, in order to lead the cleaning quantity of second raw material powder past the process chamber and herewith to shorten the duration of a cleaning cycle.

Indeed, it can be the case that the cleaning quantity of second raw material powder is contaminated by the residual share of the first raw material powder to such an extent that the raw material powder mixture which is led away must be disposed of after the passage and cannot be reused. However, the costs for many raw material powders have greatly reduced in recent years, so that the costs for the cleaning quantity of second raw material powder nowadays is very much lower than the cleaning and operational downtime costs. Furthermore, additionally to the cleaning operation mode, a rapid, manual coarse cleaning of all easily accessible facility parts, in particular the process chamber can be effected without a disassembly of parts, in order to minimise the residual shares of first raw material powder. This can be effected in a few minutes by personnel whom are less specialised and less experienced, for example by way of vacuuming. If the contamination in the raw material powder mixture which has been led away out of the raw material powder routing lies below tolerance limits, then the raw material powder mixture can even be used for the second construction job or in a different manner.

Optionally, the facility can be configured, in the cleaning operation mode, to hold a base plate of a workpiece space in a defined position. In contrast to the construction job, the workpiece space therefore does not enlarge to the bottom during the cleaning operation mode. The defined position can be a zero position which lies maximally to the top and at which the workpiece space remains practically closed and no powder bed is formed on the base plate. The cleaning quantity of second raw material powder is herein conveyed directly into an overflow or capture container. If the defined position for example is lower by one layer thickness, then although a powder bed forms, however each further layer which is deposited onto the powder bed after the first layer is preferably almost completely pushed down by the powder bed in the cleaning operation mode and is led way out of the process chamber. The periods between the layer depositions can be very much shorter in the cleaning operation mode than in the construction job since the raw material powder in the cleaning operation mode is not selectively fused between the layer depositions. The layer depositions or removals can be effected consecutively without interruption, which accelerates the cleaning operation mode. If in the cleaning operation mode no layers at all are deposited as a powder bed on the base plate, but one conveys directly into an overflow or a capture container, then the cleaning operation mode can be accelerated further. If the defined position of the base plate is a relatively low-lying position in the workpiece container, thus the workpiece space in the cleaning operation mode forms a volume which is open to the top, then one can convey directly into the workpiece space in the cleaning operation mode, i.e. the workpiece space can be used in the cleaning operation mode as a capture container for the raw material powder mixture.

Optionally, the cleaning quantity of second raw material powder can be maximally 30%, preferably maximally 10% of a quantity of second raw material powder which is required for the second construction job. The cleaning quantity can be dependent on the facility as well as the first and/or second raw material powder. Here, one may specify empirical values which specify an adequate cleaning quantity depending of the facility as well as on the first and/or second raw material powder, in order to get the residual share of first raw material powder in the raw material powder mixture below tolerance limits. Optionally, the cleaning quantity of second raw material powder can be an absolute minimal cleaning quantity, for example 5 litres, which is set for the facility.

Optionally, an upper limit for the residual share of first raw material powder in the raw material powder mixture which is led away out of the raw material powder routing in the cleaning operation mode can be predefined. This can also be a zero-tolerance, i.e. that the cleaning operation mode is ruled out for certain combinations of first and second raw material powder, since the upper limit can only be achieved by a thorough manual cleaning. The greater the contamination tolerance, the better can the cleaning operation mode be applied with little as possible cleaning quantity and short passage times. The lower the contamination tolerance, the longer can the cleaning operation mode be carried out and/or the larger can the cleaning quantity be selected.

Optionally, the facility can be configured, in the cleaning operation mode, to refeed the raw material powder mixture which is led away out of the section of the raw material powder routing, once or several times again to the section of the raw material powder routing, for example by way of a recycling system or manually. Although this lengthens the duration of the cleaning operation mode, it however utilises the cleaning quantity to an improved extent. Since it is always only a small part of the cleaning quantity which actively cleans, thus entrains first raw material powder with each passage, the first raw material powder which remains in the section of the raw material powder routing can be greatly reduced by way of this. It is also possible to clean the raw material powder mixture between passages. Such an intermediate cleaning in particular makes sense if the first and the second raw material powder can be easily and reliably separated from one another, i.e. given large differences in the grain size by way of screening or filtering or if for example one of the raw material powders is more ferromagnetic than the other by way of magnetic separation.

Optionally, the facility can further comprise an analysis unit, wherein the analysis unit is configured to determine the residual share of first raw material powder in the raw material powder mixture which in the cleaning operation mode is led away out of the section of the raw material powder routing. This makes particular sense in order to be able to determine or measure the cleaning effect. By way of the analysis unit, one can examine as to whether the facility is adequately cleaned.

Optionally, the facility can be configured, in the cleaning operation mode, to refeed the raw material powder mixture which is led away out of the section of the raw material powder routing to the section of the raw material powder routing as often and until the residual share of first raw material powder in the raw material powder mixture which is led away in the cleaning operation mode lies below a predefined upper limit. This for example can be tested by way of an analysis once, regularly or continuously during the cleaning operation mode or at the completion of this. Alternatively, this can be tested in the laboratory by random sampling by way of taking samples.

Optionally, the facility can be configured to increase the cleaning quantity of the second raw material powder if the residual share of first raw material powder in the raw material powder mixture which is led away out of the section of the raw material powder routing in the cleaning operation mode lies above a predefined upper limit. In order to reduce the consumption of cleaning quantity of second raw material powder, it can be advantageous to firstly use a smaller cleaning quantity for the cleaning operation mode and to determine the residual share of first raw material powder in the raw material powder mixture which is led away out of the section of the raw material powder routing in the cleaning operation mode, in order to examine the cleaning success. If the cleaning quantity is not sufficient due to the upper limit being exceeded, the cleaning quantity can be increased. Preferably however it is firstly not the cleaning quantity which is increased but the number of passages of the cleaning quantity through the section of the raw material powder routing of the facility which is to be cleaned.

Optionally, the facility can be operated with a predefined selection of different raw materials each as a first and second raw material powder, wherein a measure for a residual share compatibility between two of the different raw materials as the first and/or second raw material powder is stored and/or retrievable in a predefined assignment matrix. Empirical values, standardised tolerance values, upper limits and/or vetoes can be stored in the assignment matrix. The assignment matrix can assign exactly defined raw materials to one another and/or groups of raw materials. For example, certain raw materials as a group can be similar or behave equally in their residual share compatibility. For example there can be a group of aluminium-based raw material powders, e.g. AlSi₁₀Mg, AlSi₇Mg0.6 and AlSi₉Cu₃, a group of titanium-based raw material powders, e.g. Ti₆Al₄V ELI (Grade 23), TAl5, Ti (Grade 2), a group of copper-based raw material powders, e.g. CuNi₂SiCr, CuSn₁₀, CuCr₁Zr, a group of iron-based raw material powders, e.g. 316L (1.4404), 15-5PH (1.4545), 17-4PH (1.4542), 1.2709, H13 (1.2344), a group von nickel-based raw material powders, e.g. HX, IN625, IN718, IN939, and a group of cobalt-based raw material powders, e.g. CoCR28Mo6, SLM® MediDent. The assignment matrix alternatively or additionally can group raw materials according to grain sizes and assign grain size groups to one another and comprise corresponding residual share compatibilities. The assignment matrix can be stored in the facility itself and/or be stored externally, for example on an external server or in a cloud, or be able to be retrieved by the facility via a data connection.

The residual share compatibility as an entry in the assignment matrix can be for example an absolute or relative value between 0 and 1 or a percentage share which represents a measure for a tolerable residual share of first raw material powder in the raw material powder mixture which is led away out of the section of the raw material powder routing in the cleaning operation mode. This for example can be a volume share, a weight share or a quantity share. The residual share compatibility between two raw materials can also lie at zero, i.e. the cleaning operation mode is possibly not adequate for a cleaning if a certain second raw material is subsequent to a certain other first material. Given a very low residual share compatibility or a residual share compatibility of zero, a thorough manual cleaning is possibly compulsory.

According to a second aspect of the present disclosure, a generative layer construction method is provided by way of a facility for selectively manufacturing
at least one first workpiece from at least one first raw material powder in a first construction job and
at least one second workpiece from at least one second raw material powder in a second construction job,
   characterised in that between the first construction job and the second construction job the facility is cleaned in a cleaning operation mode by way of a cleaning quantity of second raw material powder being fed to at least a section of a raw material powder routing of the facility and a raw material powder mixture with a residual share of first raw material powder being led away out of the section of the raw material powder routing.

Optionally, the section of the raw material powder routing can lead through a process chamber and in the cleaning operation mode the cleaning quantity of second raw material powder can be fed to the process chamber in a layered manner as a powder bed and the raw material powder mixture be led away out of the process chamber without selectively fusing the powder bed in the cleaning operation mode.

Optionally, in the cleaning operation mode, a base plate of a workpiece space can be held in a defined position.

Optionally, the cleaning quantity of second raw material powder can be maximally 30%, preferably maximally 10% of a quantity of second raw material powder which is necessary for the second construction job.

Optionally, the cleaning quantity of second raw material powder can be an absolute minimal cleaning quantity, for example 5 litres, which is set for the facility.

Optionally, an upper limit for the residual share of first raw material powder in the raw material powder mixture which is led away in the cleaning operation mode can be set.

Optionally, in the cleaning operation mode the raw material powder mixture which is led away out of the section of the raw material powder routing can be re-fed again to the section of the raw material powder routing once or several times.

Optionally, the residual share of first raw material powder in the raw material powder mixture which is led away in the cleaning operation mode can be determined.

Optionally, in the cleaning operation mode the raw material powder mixture which is led away out of the process chamber can be fed again to the section of the raw material powder routing for so often or so long until the residual share of first raw material powder in the raw material powder mixture which is led away in the cleaning operation mode lies below a predefined upper limit.

Optionally, the cleaning quantity of second raw material powder can be increased if the residual share of first raw material powder in the raw material powder mixture which is led away in the cleaning operation mode is above a predefined upper limit.

Optionally, a measure for a residual share compatibility between two of the different raw materials as a first and/or second raw material powder can be retrieved from a predefined, stored assignment matrix.

According to a third aspect of the present disclosure, a control program is provided for a previously described facility for carrying out a previously described method. The control program can then be installed and/or carried out in the facility as software and/or hardware. The control program in particular comprises control instructions for the cleaning operation mode. The control program can be designed as an update and/or additional module to an existing control program of the facility. An already existing facility can be modified without changes to the hardware of the facility solely by way of installation and/or executability of the control program as an update and/or additional module, to the extent that it is then a facility with a cleaning operation mode according to the invention, said facility being disclosed herein.

The present disclosure is explained in more detail by way of the accompanying drawings. There are shown in:

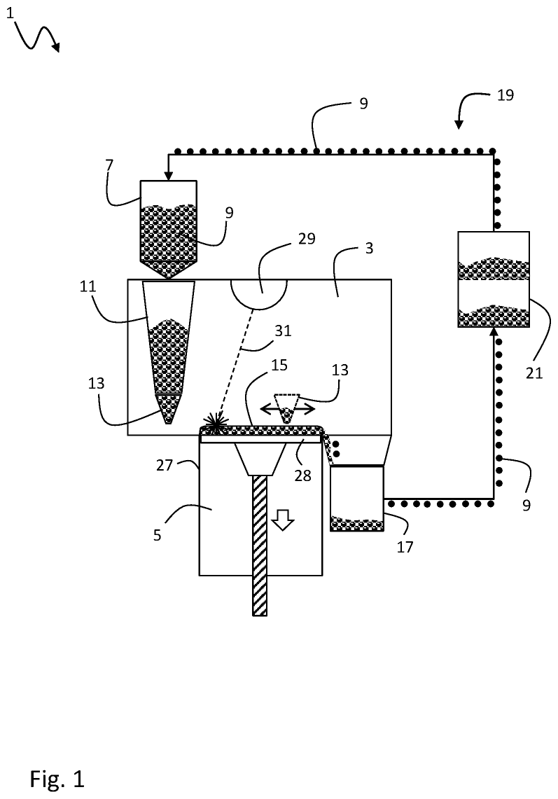

FIG. 1 a schematic representation of an embodiment example of a facility which is disclosed herein, at the beginning of a first construction job;

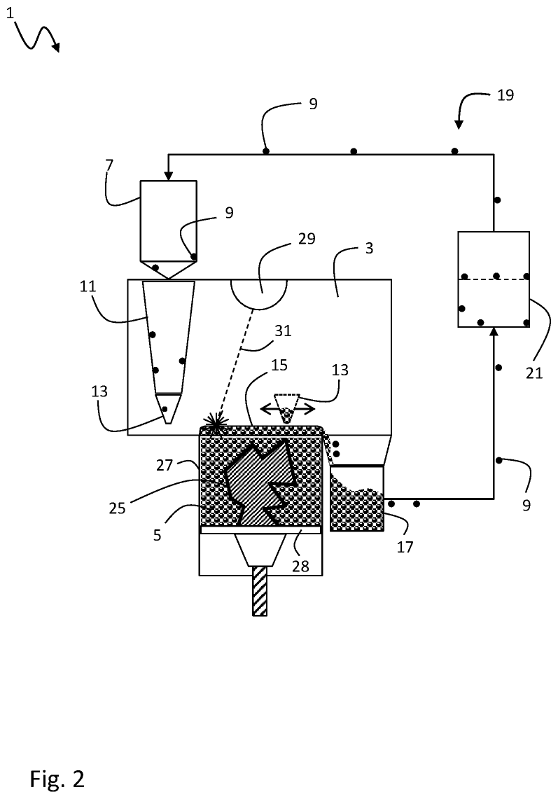

FIG. 2 a schematic representation of an embodiment example of the facility which is disclosed herein, at the end of a first construction job;

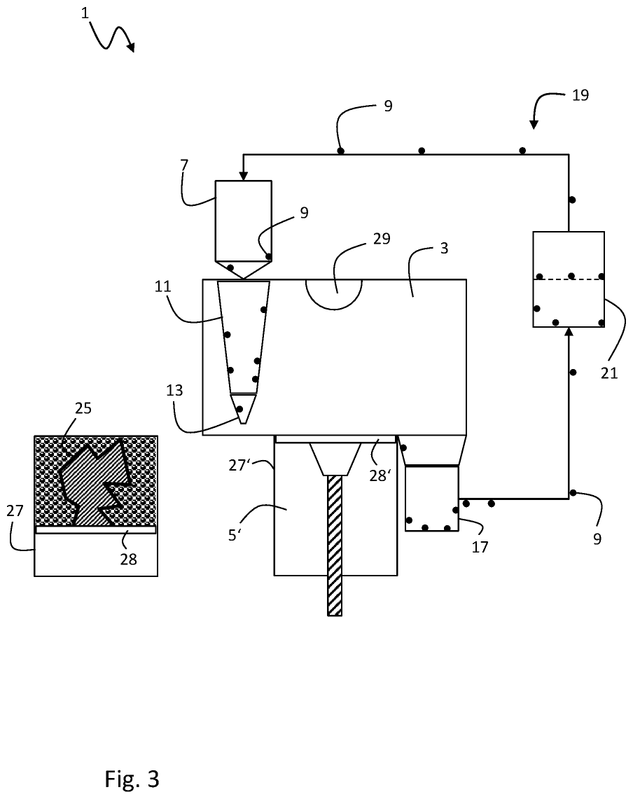

FIG. 3 a schematic representation of an embodiment example of a facility which is disclosed herein, after a first construction job;

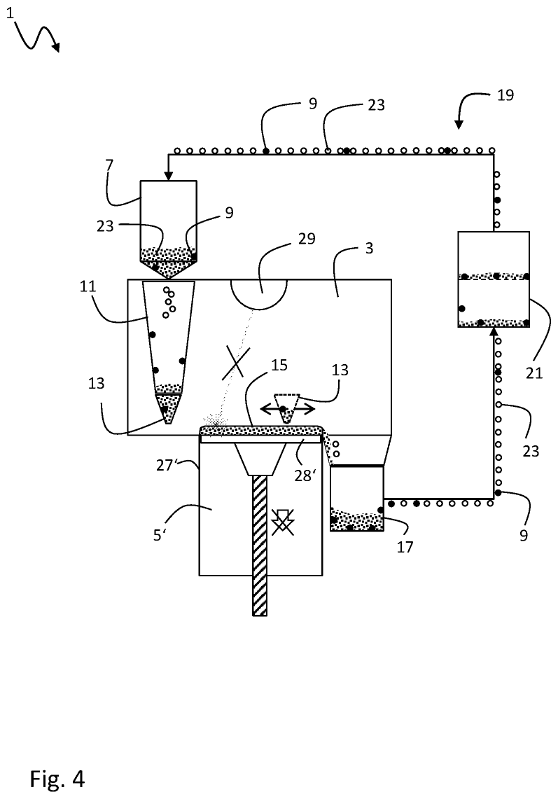

FIG. 4 a schematic representation of an embodiment example of a facility which is disclosed herein, in the cleaning operation mode before a second construction job;

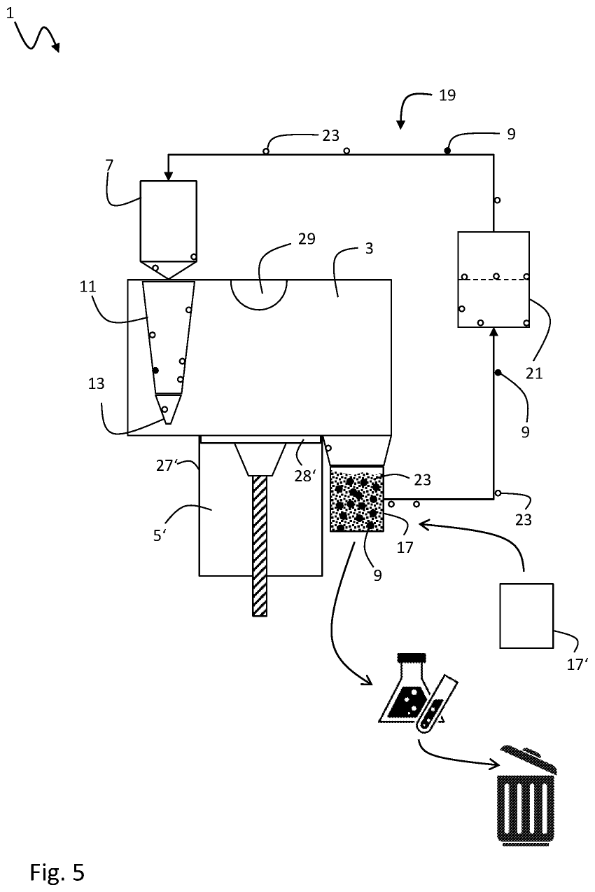

FIG. 5 a schematic representation of an embodiment example of a facility which is disclosed herein, at the end of the cleaning operation mode;

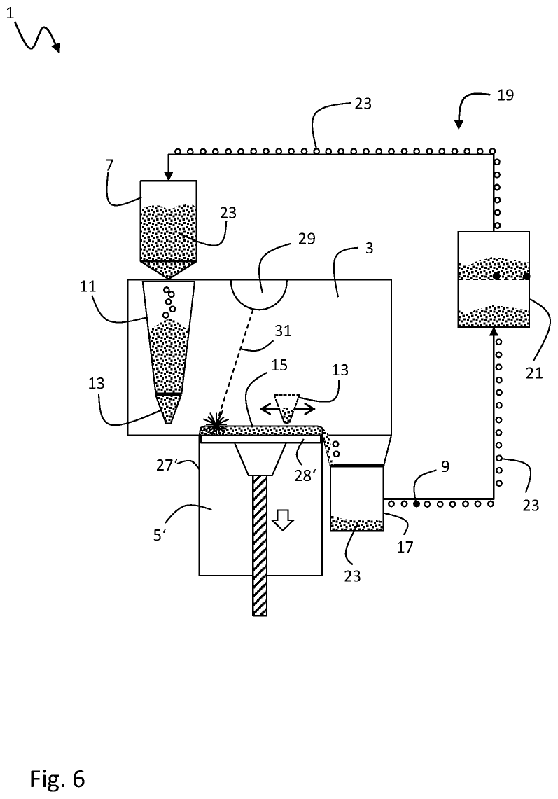

FIG. 6 a schematic representation of an embodiment example of a facility which is disclosed herein, at the beginning of a second construction job;

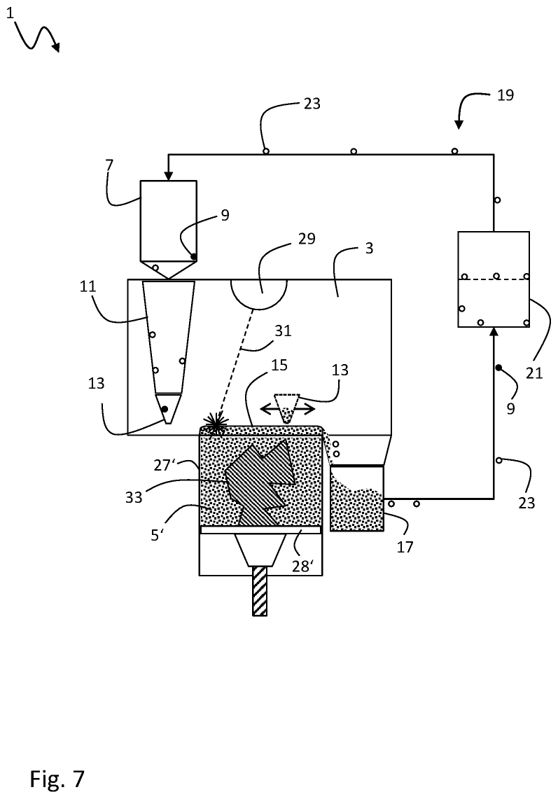

FIG. 7 a schematic representation of an embodiment example of the facility which is disclosed herein, at the end of a first construction job; and

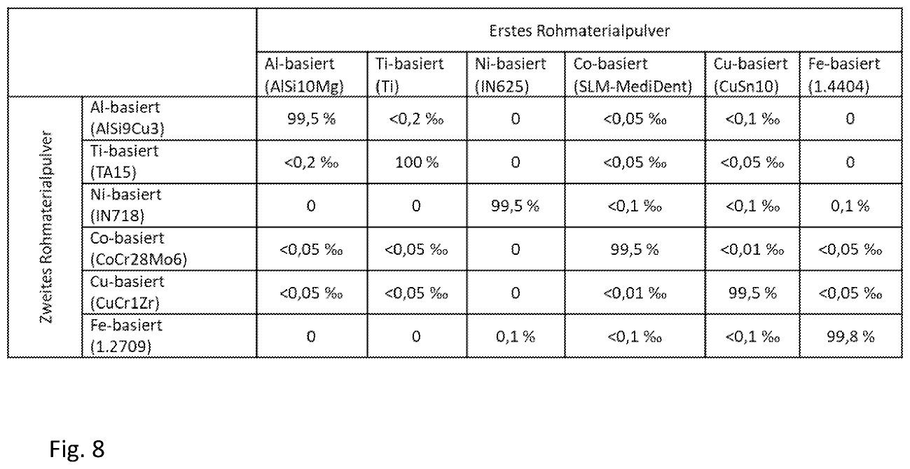

FIG. 8 a schematic representation of an embodiment example of an assignment matrix.

FIGS. 1 to 7 show a facility 1 for manufacturing three-dimensional workpieces 25, 33 by way of a generative layer construction method in the form of laser powder bed fusion (LPBF). The facility 1 here and represented in a very simplified manner comprises a raw material powder routing which leads through a process chamber 3. The facility 1 furthermore comprises a workpiece space 5, 5′ which is arranged below the process chamber 3. Furthermore, the facility 1 comprises a refilling container 7 for fresh and/or processed, i.e. recycled raw material powder 9 which feeds an intermediate store 11. A powder bed 15 of the raw material powder 9 can be deposited above the workpiece space 5 by way of a horizontally displaceable coater 13. A doctor blade or a wiper (not shown) which can be part of the coater 13 pulls the powder bed in a smooth manner at the upper side and transports excess raw material powder 9 out of the process chamber 3 into a capture container 17. The raw material powder 9 is transported downwards largely due to gravity. The raw material powder routing comprises all parts of the facility which come into contact with the respective raw material powder.

The raw material powder routing of the facility 1 here optionally comprises a recycling system 19 concerning which the raw material powder 9 which lands in the capture container 17 is fed again the refill container 7 via a filtering and processing element 21. The recycling system 19 can comprise a vacuum conveying system with which the raw material powder 9 is conveyed fluidically through conduits. However, the recycling system does not need to be a part of the facility 1, but the capture container 17 can be manually removed, emptied and the raw material powder 9 which is located therein can be processed in an external filtering and processing facility, in order to fill a new refilling container 7. For this, the refilling container 7 can be connected in a manually exchangeable manner. The advantages of the facility 1 which is disclosed herein although being more pronounced with larger facilities 1 with an integrated recycling system 19, the effect according to the invention also arises with small facilities 1 without an integrated recycling system 19.

According to the invention, the facility 1 can be operated with at least two different raw material powders 9, 23, specifically with a first raw material powder 9 which is shown in FIG. 1 to 3 and with a second raw material powder 23 which is shown in FIGS. 4 to 7. FIG. 1 shows the facility 1 at the beginning of the first construction job for manufacturing a first workpiece 25 (see FIGS. 2 and 3) from the first raw material powder 9. The workpiece space 5 is formed by a transportable workpiece container 27 which for the first construction job is positioned below a base-side opening of the process chamber 3. A vertically displaceable base plate 28 of the workpiece space 5 is arranged at the very top at the beginning of the first construction job, as is shown in FIG. 1, so that the base plate 28 is flush with the base of the process chamber 3 and essentially fills out the base-side opening of the process chamber 3. A first layer of first raw material powder 9 is then deposited onto the base plate 29 by way of the coater 13. A laser beam 31 is then led over the powder bed 15 by way of a laser light out-coupling device 29 which is located in the process chamber 3 at the roof, so that the powder bed 15 is selectively fused at desired locations. As soon as the laser fusing is completed, the base plate 28 travels downwards into the workpiece container holder 27 by a layer thickness and a new layer is deposited by way of the coater 13, said layer then being selectively fused by the laser beam 31. The coater 13 gets newly filled from the intermediate store 11 after each layer and the intermediate store 11 gets filled from the refilling container 7. In order to be able to generate a straight layer as a powder bed 15, the coater 12 always deposits an excess of raw material 9 and subsequently draws the powder bed 15 smooth, wherein the excess is transported out of the process chamber 3 into the capture container 17.

FIG. 2 shows the situation at the end of the first construction job when the first workpiece 25 has just been completed. One can already recognise that the raw material powder routing of the facility is contaminated with first raw material powder 9 after the first construction job, and specifically over all parts of the facility 1 which have come into contact with the first raw material powder 9. In FIG. 3 it is shown that for a following construction job the workpiece container 27 has been transported away and been replaced by a new workpiece container 27′ which is now positioned below the process chamber 3 of the start of a new construction job. The workpiece container 27 with the first workpiece 25 is transported into an unpacking station (not shown here) for unpacking. It is shown in FIG. 3 that the facility 1 comprises many parts of the raw material powder routing which are still contaminated with the first raw material powder 9. The process chamber 3 which is typically accessible through a service opening (not shown) can be vacuumed and/or cleaned in a relatively simple and rapid manual manner. The process chamber 3 can optionally also be pre-cleaned, post-cleaned or intermediately cleaned by way of an automatic vacuuming. Furthermore, it makes sense to convey such that the raw material powder routing of the facility 1 is empty as much as possible after the first construction job, in order to remove the first raw material powder 9 according to type as much as possible. Certain sections of the raw material powder routing of the facility such as for instance the recycling system 19, the refilling container 7, the intermediate store 11 and the coater 13 as well as the capture container 17 however cannot be manually cleaned without a large effort and without dismantling parts. If the subsequent construction job is to take place with the same raw material powder 9, then a cleaning is possibly not necessary. However, even then a cleaning operation mode can be useful in order for example to remove lumps or sintered remains of the first raw material powder 9. At all events, if another second raw material powder 23 is to be used in the same raw material powder routing for the following construction job, then it can be the case that the sections of the raw material powder routing of the facility which are contaminated with the first raw material powder 9 must be cleaned before the second construction job.

According to the invention, this cleaning of the contaminated sections of the raw material powder routing of the facility takes place in an automatic cleaning operation mode which is represented in FIG. 4, in order to avoid a complicated, manual and thorough cleaning including a part-disassembly of parts. For this, the refilling container 7 is filled with a certain cleaning quantity of second raw material powder 23 and the facility 1 is operated in a “powerless” dummy construction job or “0-Watt construction job”. This means that the cleaning quantity of second raw material powder 23 is transported through the facility 1 as in a normal construction job, but neither is the laser light outcoupling device 29 operated, nor is the base plate 28 lowered. Preferably, the cleaning operation mode takes place under an inert atmosphere and in a raw material powder routing which is sealingly closed with respect to the surroundings, analogously to a normal construction job.

Without the step of laser fusing, the individual layers are successively deposited by the coater 13 in a relatively rapid manner. However, since the base plate 28 is not lowered between the deposited layers, essentially the complete deposited layer is transported again completely into the capture container 17 after each deposition. A passage of the cleaning quantity of second raw material powder 23 through the raw material powder routing of the facility 1 can therefore be very much quicker in the cleaning operation mode than in a normal construction job.

Preferably, the cleaning quantity of second raw material powder 23 runs several times through the sections of the raw material powder routing of the facility 1 which are to be cleaned. Given the passage of cleaning quantity of second raw material powder 23, the contamination of the raw material powder routing of the facility 1 with the first raw material powder 9 is entrained. For this reason, a certain residual share of first raw material powder 9 collects in the second raw material powder 23 in the capture container 17, so that a raw material powder mixture 9, 23 forms. After a certain through-flow quantity of second raw material powder 23 which is determined by the applied cleaning quantity as well as the number of passages through the raw material powder routing of the facility 1, a stable residual share of first raw material powder 9 arises in the raw material powder mixture 9, 23 in the capture container 17. The cleaning passages in the cleaning operation mode can then be completed and the raw material powder routing of the facility 1 can be emptied into the capture container, as is shown in FIG. 5.

The capture container 17 now comprises a raw material powder mixture 9, 23 of second raw material powder 23 with a residual share of first raw material powder 9. The facility 1 to the most extent is contaminated with the second raw material powder 23 and now only has a very small residual share of contamination with the first raw material powder 9. This residual share can be determined in a separate laboratory or in an analysis unit (not shown) which is integrated into the facility, in order to decide whether the remaining contamination with residual shares of the first raw material powder 9 can be tolerated. The capture container 17 with the raw material powder mixture 9, 23 of the second raw material powder 23 with the residual share of first raw material 9 can be disposed of and a new capture container 17′ be used. The raw material powder routing of the facility 1 is subjected to the conveying to an empty as possible extent also towards the end of the cleaning operation mode. Optionally, the process chamber 3 can be cleaned manually or by way of an automatic vacuuming after the cleaning operation mode. For safety reasons, the cleaning operation mode can be configured such that the cleaning operation mode can only be operated given a closed raw material powder routing, in particular a closed process chamber door under protective atmosphere which is to say an opening of the raw material powder routing, in particular an opening of the process chamber door is not possible during the cleaning operation mode.

FIG. 6 shows the beginning of a second construction for manufacturing a second workpiece 33 (see FIG. 7) from the second raw material powder 23 which has already been used in the cleaning operation mode in FIG. 4. The contamination with the residual share of first raw material powder 9 here is below a tolerance limit. FIG. 7 shows the result at the end of the second construction job.

An assignment matrix 35 is shown by way of example in FIG. 8, said matrix being stored in the facility 1 or on an external server or in the cloud and/or being able to be retrieved from there. The assignment matrix 35 in the shown embodiment example shows six groups of raw materials which can each be used as a first raw material powder 9 or as a second raw material powder 23. A residual share compatibility of 100% means that a cleaning between the construction jobs is not necessary. A residual share compatibility of 0 means that a use of the cleaning operation mode is not allowed, since an adequate cleaning is only possible by way of a through manual cleaning amid the disassembly of individual parts of the facility 1. The assignment matrix 35 is preferably symmetrical but is does not need to be the case. The assignment matrix 35 can comprise precisely defined raw material powder instead of groups of raw materials. For example the groups can comprise the following raw materials: the group Al of aluminium-based raw material powders: e.g. AlSi₁₀Mg, AlSi₇Mg0.6 and AlSi₉Cu₃, the group Ti of titanium-based raw material powders: Ti₆Al₄V ELI (Grade 23), TAl5, Ti (Grade 2), the group Cu of copper-based raw material powders: CuNi₂SiCr, CuSn₁₀, CuCr₁Zr, the group Fe of iron-based raw material powders, e.g. 316L (1.4404), 15-5PH (1.4545), 17-4PH (1.4542), 1.2709, H13 (1.2344), the group Ni von nickel-based raw material powders, e.g. HX, IN625, IN718, IN939, and a group of cobalt-based raw material powders, e.g. CoCR28Mo6, SLM® MediDent.

### LIST OF REFERENCE NUMERALS

1 facility
3 process chamber
5, 5′ workpiece space
7 refill container
9 first raw material powder
11 intermediate store
13 coater
15 powder bed
17, 17′ capture container
19 recycling system
21 filtering and processing element
23 second raw material powder
25 first workpiece
27, 27′ workpiece container
28, 28′ base plate
29 laser light outcoupling device
31 laser beam
33 second workpiece
35 assignment matrix

1. A facility for the manufacture of selectively at least one first workpiece from at least one first raw material powder in a first construction job by way of a generative layer construction method and at least one second workpiece from at least one second raw material power in a second construction job byway of a generative layer construction method, the facility comprising:
at least one raw material powder routing configured to lead the first and/or second raw material powder during a construction job;
a raw material powder cleaning means providing a cleaning operation mode, for leading a cleaning quantity of second raw material powder at least through a section of the raw material powder routing when changing between the first construction job and the second construction job and for leading a raw material powder mixture with a residual share of a first raw material powder away out of the section of the raw material powder routing.

2. A facility according to claim 1, further comprising a process chamber, wherein the section of the raw material powder routing leads through the process chamber and in the cleaning operation mode the cleaning quantity of second raw material powder is fed to the process chamber in a layered manner as a powder bed and the raw material powder mixture is led away out of the process chamber without selectively fusing the powder bed in the cleaning operation mode.

3. A facility according to claim 1, wherein the facility is configured, in the cleaning operation mode, to hold a base plate of a workpiece space in a defined position.

4. A facility according to claim 1, wherein the cleaning quantity of second raw material powder is an absolute minimum cleaning quantity which is specified for the facility.

5. A facility according to claim 1, wherein an upper limit for the residual share of first raw material powder in the raw material powder mixture which is led away out of the raw material powder routing in the cleaning operation mode is predefined.

6. A facility according to claim 1, wherein the facility is configured, in the cleaning operation mode, to refeed the raw material powder mixture which is led away out of the section of the raw material powder routing, once or several times again to the section of the raw material powder routing.

7. A facility according to claim 1, further comprising an analysis unit, wherein the analysis unit is configured to determine the residual share of first raw material powder in the raw material powder mixture which in the cleaning operation mode is led away out of the section of the raw material powder routing.

8. A facility according to claim 1, wherein the facility is configured, in the cleaning operation mode, to refeed the raw material powder mixture which is led away out of the section of the raw material powder routing to the section of the raw material powder routing as often and until the residual share of first raw material powder in the raw material powder mixture which is led away out of the section in the cleaning operation mode lies below a predefined upper limit.

9. A facility according to claim 1, wherein the facility is configured to increase the cleaning quantity of the second raw material powder if the residual share of first raw material powder in the raw material powder mixture which is led away out of the section of the raw material powder routing in the cleaning operation mode lies above a predefined upper limit.

10. A facility according to claim 1, wherein the facility can be operated with a predefined selection of different raw materials each as the first and second raw material powder, wherein a measure for a residual share compatibility between two of the different raw materials as the first and/or second raw material powder is stored and/or retrievable in a predefined assignment matrix.

11. A generative layer construction method by way of a facility for selectively manufacturing at least one first workpiece from at least one first raw material powder in a first construction job and at least one second workpiece from at least one second raw material powder in a second construction job, the method comprising:
changing between the first construction job and the second construction job; and
cleaning the facility in a cleaning operation mode by way of feeding a cleaning quantity of second raw material powder at least through a section of a raw material powder routing of the facility and leading a raw material powder mixture with a residual share of first raw material powder away out of the section of the raw material powder routing.

12. A method according to claim 11, wherein the section of the raw material powder routing leads through a process chamber and in the cleaning operation mode the cleaning quantity of second raw material powder is fed to the process chamber in a layered manner as a powder bed and the raw material powder mixture is led away out of the process chamber without selectively fusing the powder bed in the cleaning operation mode.

13. A method according to claim 11, wherein in the cleaning operation mode a base plate of a workpiece space is held in a defined position.

14. A method according to claim 11, wherein the cleaning quantity of second raw material powder is an absolute minimal cleaning quantity which is set for the facility.

15. A method according to claim 11, wherein an upper limit for the residual share of first raw material powder in the raw material powder mixture which is led away in the cleaning operation mode is predefined.

16. A method according to claim 1, wherein in the cleaning operation mode the raw material powder mixture which is led away out of the section of the raw material powder routing is re-fed again to the section of the raw material powder routing once or several times.

17. A method according to claim 11, wherein the residual share of first raw material powder in the raw material powder mixture which is led away in the cleaning operation mode is determined.

18. A method according to claim 11, wherein in the cleaning operation mode the raw material powder mixture which is led away out of the section of the raw material routing is fed again to the section of the raw material powder routing for so often or so long until the residual share of first raw material powder in the raw material powder mixture which is led away in the cleaning operation mode lies below a predefined upper limit.

19. A method according to claim 11, wherein the cleaning quantity of second raw material powder is increased if the residual share of first raw material powder in the raw material powder mixture which is led away in the cleaning operation mode lies above a predefined upper limit.

20. A method according to claim 11, wherein a measure for a residual share compatibility between two of the different raw materials as a first and/or second raw material powder is retrieved from a predefined, stored assignment matrix.

21. (canceled)

22. A control program for a facility for a selective manufacture of at least one first workpiece from at least one first raw material powder in a first construction job by generative layer construction and at least one second workpiece from at least one second raw material power in a second construction job by generative layer construction with the facility comprising at least one raw material powder routing configured to lead the first and/or second raw material powder during a construction job; and a raw material powder cleaning means providing a cleaning operation mode, for leading a cleaning quantity of second raw material powder at least through a section of the raw material powder routing when changing between the first construction job and the second construction job and a raw material powder mixture with a residual share of a first raw material powder is led away out of the section of the raw material powder routing, the control program being non-transitory with a tangible medium for executing the steps of:
changing between the first construction job and the second construction job; and
cleaning the facility in a cleaning operation mode by way of feeding a cleaning quantity of second raw material powder at least through a section of a raw material powder routing of the facility and leading a raw material powder mixture with a residual share of first raw material powder away out of the section of the raw material powder routing.
